(19) United States
(12) Patent Application Publication
(10) Pub. No.: US 2006/0186853 A1
(43) Pub. Date: Aug. 24, 2006

(54) Method for identifying the rotation of a stepper motor driving at least one hand of a clock

(76) Inventors: Hanna Brummack, Finkenweg (DE); Wolfram Hodapp, Zimmern (DE)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 10/550,460

(22) PCT Filed: Dec. 4, 2003
(86) PCT No.: PCT/EP03/13670

§ 371 Date: Sep. 26, 2005

(30) Foreign Application Priority Data
Mar. 31, 2003 (DE) 103 14 426.9

(51) Int. Cl. G05B 19/40

(52) U.S. Cl. 318/685

(57) ABSTRACT

In a method for identifying the rotation of a stepper motor which includes a rotor provided with a motor coil driving at least one hand of a timepiece, wherein a drive voltage pulse and a first detection voltage pulse are delivered to the motor coil, and wherein the position of the rotor is determined with the aid of a first pulse response to the first detection voltage pulse. The method includes delivering to the motor coil a second detection voltage pulse having a polarity opposite to the polarity of the first detection voltage pulse, and determining the position of the rotor in accordance with a second pulse response to the second detection pulse. Optionally, there may be delivered to the motor coil a stabilization voltage pulse having a polarity opposite to the polarity of the first drive voltage pulse.

### BACKGROUND

The invention relates to a method for identifying the rotation of a stepper motor comprising a rotor provided with a motor coil driving at least one hand of a timepiece, wherein a drive voltage pulse and a detection voltage pulse are delivered to the motor coil, and wherein the position of the rotor is determined with the aid of those pulses.

A bipolar stepper motor (Lavet motor) is usually used to drive the hands of an analog timepiece. This motor is driven by drive voltage pulses which change polarity with each step.

In the worst case, the driving circuit can either always supply the energy sufficient for reliable rotation—or an adaptive control can be employed adjusting the energy contained in the drive voltage pulse to the surrounding conditions to guarantee reliable functioning of the motor in the entire working voltage range with a load from hands having different moments of inertia and different degrees of smoothness in the movement of gears.

An adaptive control is of great advantage especially in solar-powered wristwatches: firstly, to decrease electric power consumption by the watch as much as possible and, secondly, the voltage of the accumulator can fluctuate to a much higher degree than in a battery-powered timepiece.

For example, such an adaptive control is based on the principle of rotation identification, which means the electronics have sufficient intelligence to identify an executed motor step and always supply only as much energy as actually required.

A certain number of possible drive voltage pulses with different amounts of energy are usually available. The selection of the actual pulse is controlled through identification of rotation whereby a detection phase follows the drive voltage pulse. If the motor did not execute the step, then a stronger pulse is delivered to compensate for the loss of time and the drive phase is increased by one. Checks are conducted at regular intervals to determine if the driving phase with the lowest amount of energy is again sufficient to drive the motor.

A distinction is made between dynamic and static rotation identification.

The dynamic rotation identification evaluates the voltage induced based on the rotor movement, especially the dying-out of the rotor in its new position, which means that the detection phase takes place directly after the drive voltage pulse. The disadvantage of this method is its voltage dependency. The signal is dependent on the working voltage and cannot be evaluated, under certain circumstances, in the entire working voltage range for the same criteria.

The static rotation identification is based on the determination of the polarity of the rotor. The inductance of the motor coil depends on the position of the rotor, which means, through measurement of the inductance it can be determined if the rotor is located in its required position. A prerequisite for this method is that the rotor does no longer oscillate, which means the detection clearly takes place only after the rotation. The disadvantage of this method is the fact that the rotor must not be in the center (axial) position to obtain clear results.

It is therefore the object of the invention to introduce a method for identifying the rotation of a stepper motor driving at least one hand of a timepiece whereby the position of the rotor of the motor can be detected more reliably.

### SUMMARY OF THE INVENTION

This object is achieved through a method for identifying the rotation of a stepper motor comprising a rotor provided with a motor coil and driving at least one hand of a timepiece.

The invention is generally based on a method for identifying the rotation of a stepper motor comprising a rotor provided with a motor coil driving at least one hand of a timepiece whereby a drive voltage pulse and a first detection voltage pulse are delivered to the motor coil and whereby the position of the rotor is determined with the aid of the first pulse response to this first detection voltage pulse.

According to the invention it is proposed that a second detection voltage pulse with a polarity opposite to the polarity of the first detection voltage pulse is delivered to the motor coil and a second pulse response to the second detection voltage pulse is additionally used to determine the position of the rotor. The dependability is considerably increased through these measures compared to a method working only with one detection voltage pulse or a method working with several detection voltage pulses but with only one polarity.

The invention proposes alternatively or additionally to the above-described measure that a stabilization voltage pulse with a polarity opposite to the polarity of the drive voltage pulse and preceding the first detection voltage pulse is delivered to the motor coil. A stabilization phase thus precedes the actual detection phase, in which the rotor is brought reliably into an accurately detectable position. A distinctively lower fault rate can be detected when the above-described stabilization voltage pulse is used whereby this applies even in a static rotation identification method in which only the pulse response of a single detection voltage pulse is evaluated or in which the pulse responses of a plurality of homopolar detection voltage pulses are evaluated.

The invention proposes in a preferred variant that the position of the rotor is determined from comparison of the pulse responses. Deviations of the pulse response associated to the period of time and/or amplitude indicate a faulty position of the rotor. However, asymmetries caused by the manufacturing process can also be computed in a simple way.

An especially simple variant of the invention proposes that the amplitudes of the pulse responses are compared to one another. It is therefore not required that the entire period of time of the respective pulse responses are compared to one another. As a rule, the information about the rotor in the motor housing or relative to the stator of the stepper motor can already be determined from the amplitudes of the respective pulse responses.

In a special embodiment of this variant it is proposed according to the invention that a deviation from the actual position of the rotor relative to the required position is detected when the difference of the amplitudes of the pulse responses exceeds a predetermined threshold.

It has been shown to be of advantage to deliver the detection voltage pulses only several drive voltage pulse periods after the drive voltage pulse since the rotor does not oscillate any more at this time.

It is furthermore proposed according to the invention that the periods of the detection voltage pulse are about one tenth of the periods of the drive voltage pulse. Typical values for the drive voltage pulse periods are 3-8 ms, and 0.5 ms for the detection voltage pulse periods. The rotor of the stepper motor is then not moved considerably from its stationary position through a detection voltage pulse so that the measuring system supplies a definite measurement value.

It is further proposed according to the invention that the second detection voltage pulse will deliver several periods of pulses after the first detection voltage pulse. Parasitic oscillations of the rotor based on the first detection voltage pulse will have died down considerably so that no parasitic oscillations from the first detection phase have to be taken into consideration during the evaluation of the pulse response to the second detection voltage pulse.

Even though the accuracy of the rotation identification method does not depend on whether the stabilization voltage pulse precedes or follows the drive voltage pulse, it has been shown to be favorable to let the stabilization voltage pulse follow the drive voltage pulse. Experimental tests have shown that optimal results are achieved when the stabilization voltage pulse is delivered a few pulse periods after the drive voltage pulse.

It has been shown to be especially favorable when the duration of the stabilization voltage pulse is approximately 10 percent to 50 percent of the duration of the drive voltage pulse.

### BRIEF DESCRIPTION OF THE DRAWING

A preferred embodiment of the invention is now described in more detail with the aid of a drawing, in which:

The sole FIGURE shows a voltage pulse sequence as it can be used in the Roda Cal 775 stepper motor movement.

### DETAILED DESCRIPTION OF THE PREFERRED EMBODIMENT

The object of the invention is a novel variant of the static rotation identification. Two short detection voltage pulses 3, 4 of opposite polarity are delivered to the motor coil, and the pulse responses are compared to one another for the purpose of detection.

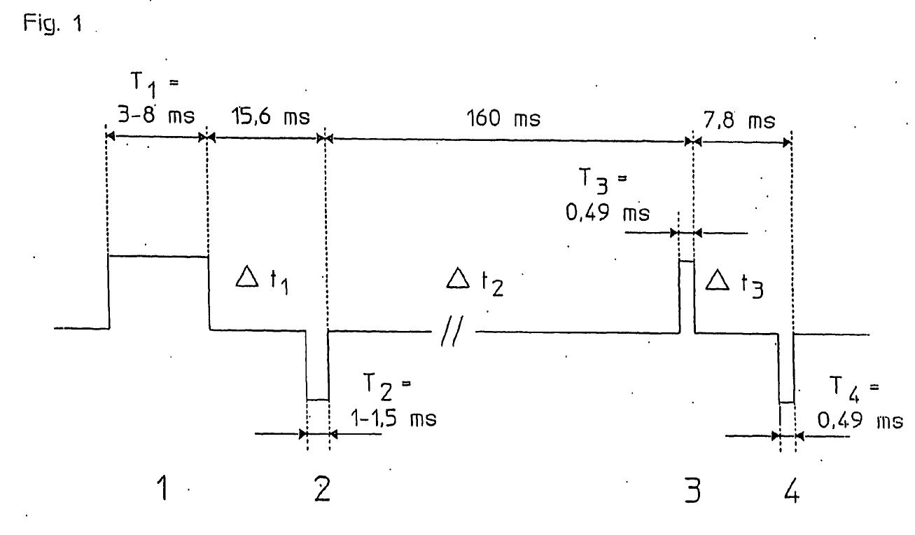

In the present embodiment example of FIG. 1, the detection phase starts approximately 180 ms after the drive voltage pulse 1. The duration T3, T4 of each of the detection voltage pulses 3, 4 is approximately 0.5 ms and the pause Δt₃ between the detection voltage pulses 3 and 4 is approximately 8 ms. A resistor of 12 kΩ is connected in series to the Ronda Cal 775 stepper motor movement to favorably influence the time constant of the system for measurement. The amplitude difference of the two response pulses must exceed a determinable threshold value so that an error can be detected. The reliability is clearly increased through this differentiating method compared to a method working with only one pulse or with only one polarity.

Through the drive with optimized energy it is not ensured in each case that the rotor is in one of the two stable positions at the time of detection. The detection is at risk if the rotor has stopped in a center position. If no error is detected—even if the step has not been executed completely—then the rotor falls back during the next drive voltage pulse and the timepiece looses two seconds.

To avoid this event, an additional stabilization voltage pulse 2 is delivered prior to the actual detection phase, bringing the rotor reliably into a correctly detectable position. This stabilization voltage pulse 2 occurs approximately 160 ms before the first detection voltage pulse 3, which means it follows the drive voltage pulse 1 by approximately 15 ms after the pause (Δt₃). Its duration T₂ is dependent on the duration T₁ of the drive voltage pulse 1 and its polarity is opposite to the one of the drive voltage pulse 1. If the rotor has therefore stopped in an undesired center position, then the rotor is brought again into its original position by means of the stabilization voltage pulse 2.

Since the rotor has to stop always before or directly at the point of maximal potential energy for physical reasons, but never after said point, and if the rotor stops in such an unstable position, it is sensible in view of energy to select a polarity for the stabilization voltage pulse 2 that is opposite to the one of the drive voltage pulse 1. More energy would have to be exerted in a selection of a polarity that is the same as the one of the drive voltage pulse 1 to bring the rotor reliably into a stable position.

However, if the rotor has already clearly reached its new position through the drive voltage pulse 1, the stabilization voltage pulse 2 has then the function of preparing the next step. Magnetic biasing of the motor occurs or the rotor is already slightly pulled in the direction of the next step taking up the play from the meshing gears. Consequently, the next drive voltage pulse 1 needs again less energy than would be necessary without a preceding stabilization voltage pulse 2; which means, the energy used for stabilization is not lost but contributes fully to the next movement.

The drive voltage pulse 1 is not chopped in the present case. The duration T2 of the stabilization pulse 2 is about one third of the duration T2 of the drive voltage pulse 1.

1-10. (canceled)

11. A method for identifying the rotation of a stepper motor which includes a rotor provided with a motor coil driving at least one hand of a timepiece, comprising the steps of:
A) delivering to the motor coil a drive voltage pulse and a first detection pulse;
B) delivering to the motor coil a second detection voltage pulse having a polarity opposite to the polarity of the first detection voltage pulse; and
C) determining the position of the rotor in accordance with first and second pulse responses to the first and second detection pulses, respectively.

12. The method according to claim 12, further comprising delivering to the motor coil, prior to step B, a stabilization voltage pulse having a polarity opposite to the polarity of the first drive voltage pulse.

13. The method according to claim 11, wherein step C comprises determining the position of the rotor from a comparison of the first and second pulse responses.

14. The method according to claim 13, wherein the comparison comprises comparing the amplitudes of the first and second pulse responses to one another.

15. The method according to claim 14, wherein a deviation from an actual position of the rotor relative to a required position is detected when the difference between the amplitudes of the first and second pulse responses exceeds a predetermined threshold.

16. The method according to claim 11, wherein the first and second detection voltage pulses are delivered several drive voltage pulse periods (T₁) after the delivery of the drive voltage pulse.

17. The method according to claim 11, wherein the periods (T₃, T₄) of the first and second detection voltage pulses are each about one tenth of the drive voltage pulse period (T₁).

18. The method according to claim 11, wherein the second detection voltage pulse delivers several periods of detection voltage pulses after the first detection voltage pulse.

19. The method according to claim 12, wherein the stabilization voltage pulse follows the drive voltage pulse.

20. The method according to claim 12, wherein the stabilization voltage pulse is delivered a plurality of drive voltage pulse periods after the drive voltage pulse.

21. The method according to claim 12, wherein the duration (T₂) of the stabilization voltage pulse is approximately 10 percent to 50 percent of the duration of the drive voltage pulse duration (T₁).

22. In a method for identifying the rotation of a stepper motor which includes a rotor provided with a motor coil driving at least one hand of a timepiece, wherein a drive voltage pulse and a first detection voltage pulse are delivered to the motor coil and wherein the position of the rotor is determined with the aid of a first pulse response to the first detection voltage pulse, the improvement comprising the steps of:
A) delivering to the motor coil a stabilization voltage pulse having a polarity opposite to the polarity of the first drive voltage pulse, and thereafter
B) delivering to the motor coil a second detection voltage pulse having a polarity opposite to the polarity of the first detection voltage pulse.
